(19) United States
(12) Patent Application Publication
(10) Pub. No.: US 2020/0207357 A1
(43) Pub. Date: Jul. 2, 2020

(54) MODIFYING VEHICLE BEHAVIOR BASED ON DATA FROM A DYNAMICALLY UPDATED ROADWAY COEFFICIENT OF FRICTION DATABASE

(71) Applicant: Robert Bosch GmbH, Stuttgart (DE)

(72) Inventors: Troy McCormick, Milford, MI (US); Anthony Farrell, Brooklyn, MI (US); Hirak Chanda, Troy, MI (US); Ankit Shah, Canton, MI (US); Sivaraja Velusamy, Northville, MI (US)

(21) Appl. No.: 16/286,116

(22) Filed: Feb. 26, 2019

Related U.S. Application Data
(60) Provisional application No. 62/785,471, filed on Dec. 27, 2018.

(51) Int. Cl. B60W 40/068; B60W 30/14; B60W 30/02; B60R 22/195; B60W 10/18; B60W 50/14; G01C 21/34; G01C 21/36; G06F 16/29; G06F 16/23

(52) U.S. Cl. CPC B60W 40/068; B60W 30/14; B60W 30/02; B60R 22/195; B60W 10/18; B60W 2050/143; G01C 21/3461; G01C 21/3415; G01C 21/3697; G06F 16/29; G06F 16/2358; B60W 50/14

(57) ABSTRACT

A system for modifying vehicle behavior based on data from a dynamically updated roadway coefficient of friction database. The system includes a roadway coefficient of friction database and an electronic computing device. The electronic computing device includes a first electronic processor that is configured to receive a current coefficient of friction and a location of a vehicle and depending on a criterion, replace, in the roadway coefficient of friction database, a previous coefficient of friction with the current coefficient of friction. The first electronic processor is also configured to receive a request for a coefficient of friction associated with a location and transmit the coefficient of friction associated with the location. Additionally, the system includes a plurality of vehicles each including a second electronic processor. Each second electronic processor is configured to perform a preventative measure based on the coefficient of friction received from the electronic computing device.

### RELATED APPLICATIONS

This application claims priority to U.S. Provisional Patent Application No. 62/785,471, filed Dec. 27, 2018, the entire content of which is hereby incorporated by reference.

### SUMMARY

The coefficient of friction of a surface of a roadway effects the performance of the vehicles traveling on it. For example, the lower the coefficient of friction of a roadway the more likely a vehicle is to experience slippage when the vehicle accelerates or decelerates. Therefore, it is beneficial to create a dynamically updating roadway coefficient of friction database. The embodiments described herein provide, among other things, a method and system for updating data in a roadway coefficient of friction database. Embodiments described herein also provide, among other things, a method and system for preventing wheel slippage of vehicles based on data from the roadway coefficient of friction database.

One embodiment provides a system for modifying vehicle behavior based on data from a dynamically updated roadway coefficient of friction database. The system includes a roadway coefficient of friction database and an electronic computing device. The electronic computing device includes a first electronic processor that is configured to receive a current coefficient of friction and a location of a vehicle and depending on a criterion, replace, in the roadway coefficient of friction database, a previous coefficient of friction associated with the location with the current coefficient of friction. The first electronic processor is also configured to receive, from a vehicle, a request for a coefficient of friction associated with a location and transmit, to the vehicle, the coefficient of friction associated with the location. Additionally, the system includes a plurality of vehicles. Each vehicle of the plurality of vehicles includes a second electronic processor. Each second electronic processor is configured to perform a preventative measure based on the coefficient of friction received from the electronic computing device.

Another embodiment provides a method for modifying vehicle behavior based on data from a dynamically updated roadway coefficient of friction database. The method includes receiving, with a first electronic processor of an electronic computing device, a current coefficient of friction and a location of a vehicle. The method also includes replacing, in the roadway coefficient of friction database, a previous coefficient of friction associated with the location with the current coefficient of friction depending on a criterion. The method further includes receiving, with the first electronic processor, a request for a coefficient of friction associated with a location from a vehicle, transmitting, with the first electronic processor, the coefficient of friction associated with the location to the vehicle, and performing, with a second electronic processor of the vehicle, a preventative measure based on the coefficient of friction received from the electronic computing device.

Other aspects, features, and embodiments will become apparent by consideration of the detailed description and accompanying drawings.

### BRIEF DESCRIPTION OF THE DRAWINGS

FIG. 1 is a block diagram of a system for modifying vehicle behavior based on data from a dynamically updated roadway coefficient of friction database according to some embodiments.

FIG. 2 is a block diagram of a vehicle of the system of FIG. 1 according to some embodiments.

FIG. 3 is a block diagram of an electronic computing device of the system of FIG. 1 according to some embodiments.

FIG. 4 is a block diagram of an electronic controller of the vehicle of FIG. 2.

FIG. 5 is a flowchart of a method for using the system of FIG. 1 to modify vehicle behavior based on data from a dynamically updated roadway coefficient of friction database according to some embodiments.

FIG. 6 is a flowchart of a method for calculating a current coefficient of friction of a roadway at a location of the vehicle of FIG. 2 according to some embodiments.

FIG. 7 is a flowchart of a method for performing a preventative measure according to some embodiments.

FIG. 8 is an illustration of a map displayed by a display device of the vehicle of FIG. 2 and including suggested routes and the coefficients of friction associated with sections of roadways included in the suggested routes.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

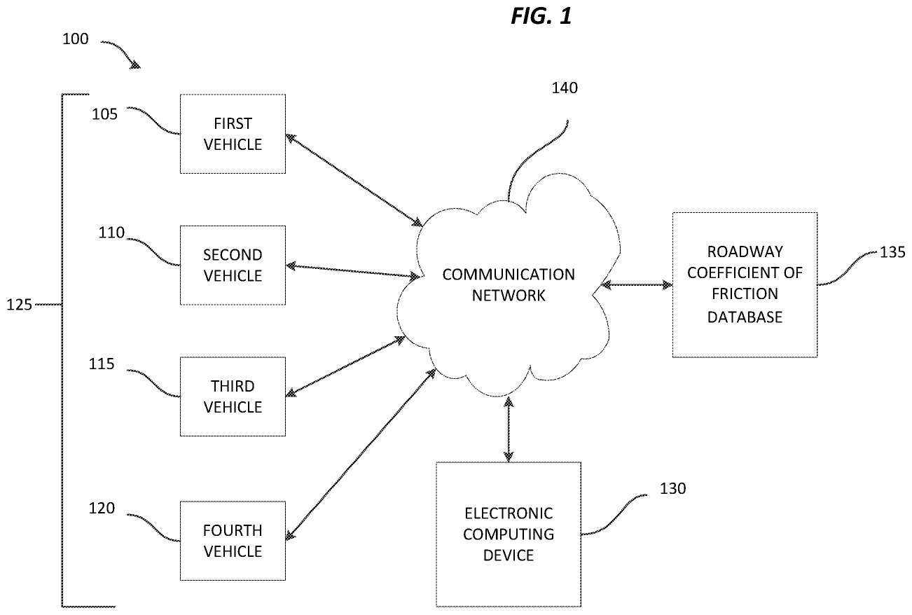

FIG. 1 illustrates a system 100 for modifying vehicle behavior based on data from a dynamically updated roadway coefficient of friction database. The system 100 includes, among other things, a first vehicle 105, a second vehicle 110, a third vehicle 115, a fourth vehicle 120 (sometimes referred to herein collectively as a plurality of vehicles 125), an electronic computing device 130, and a roadway coefficient of friction database 135. The plurality of vehicles 125, the electronic computing device 130, and the roadway coefficient of friction database 135 communicate over one or more wired or wireless communication networks 140. Portions of the wireless communication networks 140 may be implemented using a wide area network, such as the Internet, a local area network, such as a Bluetooth™ network or Wi-Fi, and combinations or derivatives thereof. It should be understood that the system 100 may include various numbers of vehicles, and the four vehicles illustrated in FIG. 1 are purely for illustrative purposes. Similarly, it should also be understood that the system 100 may include various numbers of electronic computing devices and the single electronic computing device 130 illustrated in FIG. 1 is purely for illustrative purposes. The system 100 may include various numbers of roadway coefficient of friction databases and the single roadway coefficient of friction database 135 illustrated in FIG. 1 is purely for illustrative purposes. Also, in some embodiments, the plurality of vehicles 105, 110, 115, 120, the electronic computing device 130, and the roadway coefficient of friction database 135 may communicate with each other through one or more intermediary devices (not shown).

The embodiment illustrated in FIG. 1 provides but one example of the components and connections of the system 100. However, these components and connections may be constructed in other ways than those illustrated and described herein.

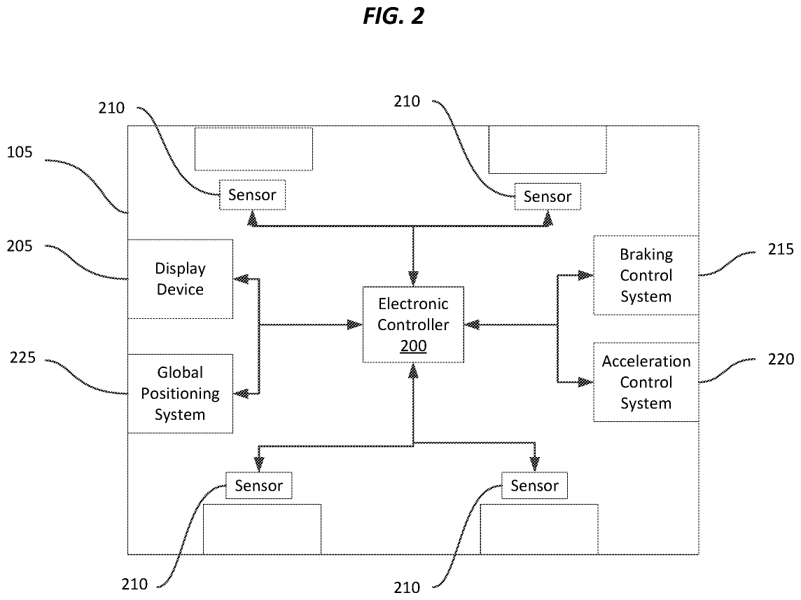

FIG. 2 illustrates one example of the components included in the first vehicle 105. It should be understood that the second vehicle 110, third vehicle 115, and fourth vehicle 120 may include similar components and connections to those illustrated as being included in the first vehicle 105. The first vehicle 105, although illustrated as a four-wheeled vehicle, may encompass various types and designs of vehicles. For example, the first vehicle 105 may be an automobile, a motorcycle, a truck, a bus, a semi-tractor, and others. In the example illustrated, the first vehicle 105 includes an electronic controller 200, a display device 205, a plurality of sensors 210 located at one or more of the wheels of the first vehicle 105 and configured to detect wheel slippage, a braking control system 215, an acceleration control system 220, and a global positioning system (GPS) 225. The components of the first vehicle 105 may be of various constructions and may use various communication types and protocols.

The electronic controller 200 may be communicatively connected to the display device 205, plurality of sensors 210, braking control system 215, acceleration control system 220, and GPS 225 via various wired or wireless connections. For example, in some embodiments, the electronic controller 200 is directly coupled via a dedicated wire to each of the above-listed components of the first vehicle 105. In other embodiments, the electronic controller 200 is communicatively coupled to one or more of the components via a shared communication link such as a vehicle communication bus (for example, a controller area network (CAN) bus) or a wireless connection.

Each of the components of the first vehicle 105 may communicate with the electronic controller 200 using various communication protocols. The embodiment illustrated in FIG. 2 provides but one example of the components and connections of the first vehicle 105. However, these components and connections may be constructed in other ways than those illustrated and described herein. For example, it should be understood that the electronic controller 200 may include one or more sensors 210 and that the four sensors 210 included in FIG. 2 are merely for illustrative purposes.

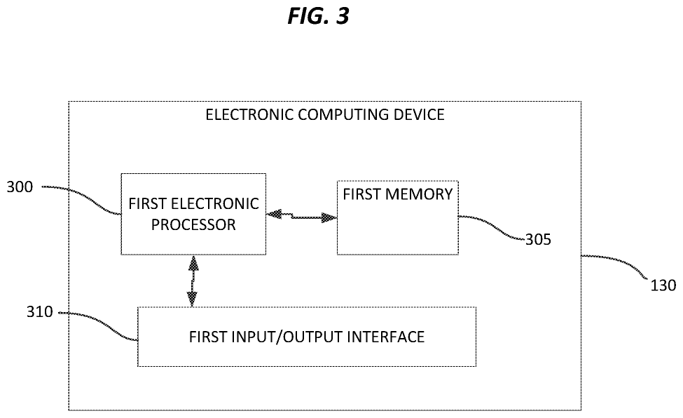

FIG. 3 is a block diagram of the electronic computing device 130 of the system 100. The electronic computing device 130 includes, among other things, a first electronic processor 300 (such as a programmable electronic microprocessor, microcontroller, or similar device), a first memory 305 (for example, non-transitory, computer readable memory), and a first input/output interface 310. The first electronic processor 300 is communicatively connected to the first memory 305 and the first input/output interface 310. As will be described in further detail below, the first memory 305 may include computer executable instructions for determining when to update the data in the coefficient of friction database 135. The first electronic processor 300, in coordination with the first memory 305 and the first input/output interface 310, is configured to implement, among other things, the methods described herein.

The functionality described herein as being performed by the electronic computing device 130 may be distributed amongst several electronic computing devices. Additionally, the electronic computing device 130 may contain sub-modules that include additional electronic processors, memory, or application specific integrated circuits (ASICs) for handling input/output functions, processing of signals, and application of the methods listed below. In other embodiments, the electronic computing device 130 includes additional, fewer, or different components.

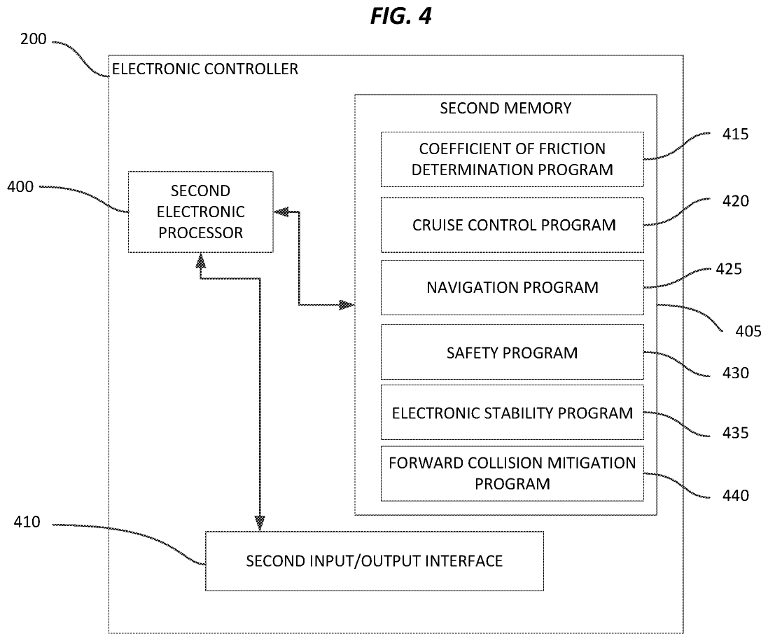

FIG. 4 is a block diagram of the electronic controller 200 of the first vehicle 105. The electronic controller 200 includes a plurality of electrical and electronic components that provide power, operation control, and protection to the components and modules within the electronic controller 200. The electronic controller 200 includes, among other things, a second electronic processor 400 (such as a programmable electronic microprocessor, microcontroller, or similar device), a second memory 405 (for example, non-transitory, computer readable memory), and a second input/output interface 410. The second electronic processor 400 is communicatively connected to the second memory 405 and the second input/output interface 410. The second electronic processor 400, in coordination with the second memory 405 and the second input/output interface 410, is configured to implement, among other things, the methods described herein.

As will be described in further detail below, the second memory 405 includes computer executable instructions (or programs) for determining a coefficient of friction of a roadway and modifying the behavior of a vehicle based on a received coefficient of friction. In the example illustrated in FIG. 4, the second memory 405 includes a coefficient of friction determination program 415, a cruise control program 420, a navigation program 425, a safety program 430, an electronic stability program 435, and a forward collision mitigation program 440. In some embodiments, the safety program 430 communicates with the cruise control program 420, electronic stability program 435, forward collision mitigation program 440, or a combination of the foregoing to adjust values included in the programs that are associated with the safety of the vehicle and its passengers. For example, the safety program 430 may adjust the maximum braking force that the cruise control program 420 may request the braking control system 215 to apply to the first vehicle 105. It should be understood that the second memory 405 may include more, fewer, or different programs than those illustrated in FIG. 4. It should also be understood that functionality or values described herein as being associated with one program may, in other embodiments, be associated with a different program. The electronic controller 200 may be implemented in several independent controllers (for example, programmable electronic controllers) each configured to perform specific functions or sub-functions. Additionally, the electronic controller 200 may contain sub-modules that include additional electronic processors, memory, or application specific integrated circuits (ASICs) for handling input/output functions, processing of signals, and application of the methods listed below. In other embodiments, the electronic controller 200 includes additional, fewer, or different components. Thus, the programs may also be distributed among one or more processors.

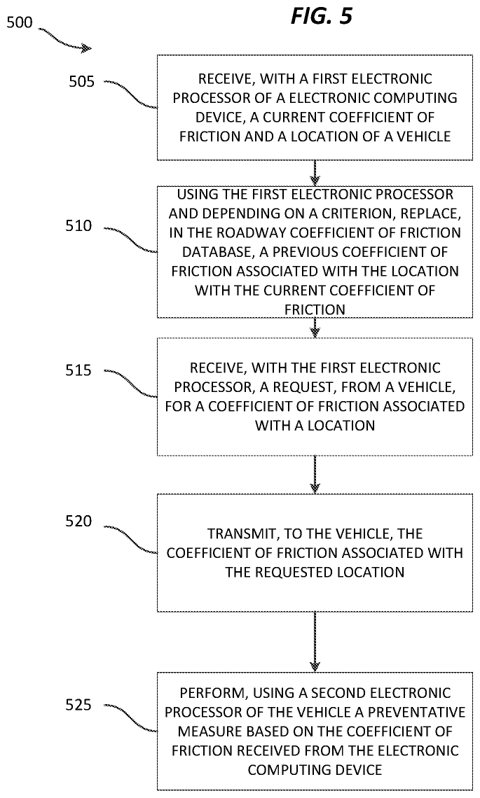

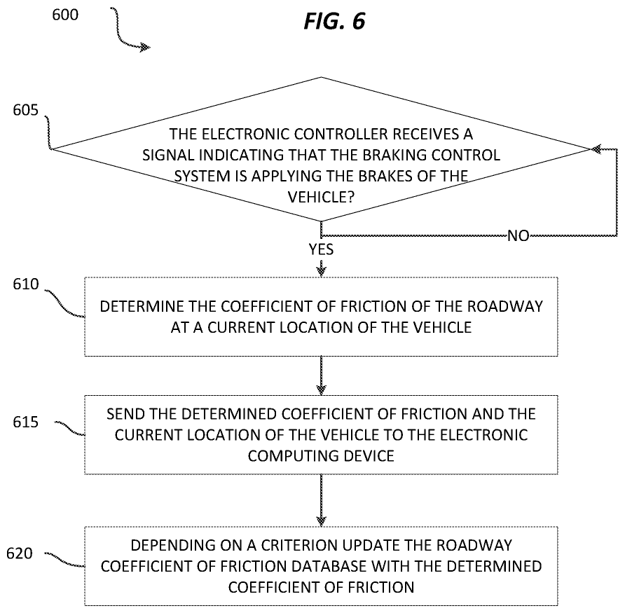

FIG. 5 illustrates an example of a method 500 for modifying vehicle behavior based on data from a dynamically updated roadway coefficient of friction database. The method 500 begins when the first electronic processor 300 receives, from a vehicle, a current coefficient of friction and a location of the vehicle (for example, the location of the first vehicle 105 determined by the GPS 225). The current coefficient of friction may be calculated when the second electronic processor 400 executes the coefficient of friction determination program 415. FIG. 6 illustrates an example method 600 for calculating the current coefficient of friction. The method begins at step 605 when the second electronic processor 400 receives a signal indicating that the braking control system 215 is applying the brakes of the vehicle. It should be understood that, in some embodiments, the method 600 begins when the second electronic processor 400 receives a signal indicating that the acceleration control system 220 is applying a force to the vehicle. In some embodiments, the braking control system 215 and the acceleration control system 220 transmit signals to the second electronic processor 400 indicating the force being applied to the first vehicle 105. The second electronic processor 400 also receives signals from one or more sensors of the plurality of sensors 210 indicting the wheels of the first vehicle 105 are slipping. For example, the second electronic processor 400 receives a signal indicating wheel slippage when the braking control system 215 applies a braking force to the first vehicle 105 or when the acceleration control system 220 applies an acceleration force to the first vehicle 105. At step 610 the second electronic processor 400 determines the current coefficient of friction of the roadway at the location of the first vehicle 105 based on the force that the braking control system 215 or the acceleration control system 220 applies to the first vehicle 105 and whether the wheels of the first vehicle 105 slip. At step 615 the first vehicle 105 sends the determined coefficient of friction and the current location of the vehicle to the electronic computing device 130. As will be described in further detail below with regards to step 510 of the method 500, at step 620 the electronic computing device 130 updates the roadway coefficient of friction database 135 with the determined coefficient of friction depending on a criterion.

It should be understood that the roadway coefficient of friction database 135 may store one coefficient of friction for a predetermined length of roadway. For example, the roadway coefficient of friction database 135 may store one coefficient of friction for each quarter mile of a roadway. When a coefficient of friction associated with a location is described herein, the coefficient of friction associated with the location is associated with a predetermined length of roadway.

Returning to the method 500, at step 510, the first electronic processor 300, replaces a previous coefficient of friction associated with the location with the current coefficient of friction in the roadway coefficient of friction database 135 depending on a criterion. In some embodiments, the criterion is at least one selected from the group consisting of weather conditions at the location, rate of vehicles traveling through the location, and an amount of time that has passed since the previous coefficient of friction was added to the roadway coefficient of friction database. In one example, the previous coefficient of friction associated with the location is replaced with the current coefficient of friction when the electronic computing device 130 receives data indicating a change in weather at the location. In another example, the previous coefficient of friction associated with the location is replaced with the current coefficient of friction when the previous coefficient of friction was stored in the roadway coefficient of friction database 135 at least a predetermined amount of time ago. The predetermined amount of time may depend on the rate that vehicles travel through the location (for example, the average number of vehicles that travel through a location during a predetermined amount of time). In another example, the previous coefficient of friction associated with the location is replaced with the current coefficient of friction when the current coefficient of friction is lower than the previous coefficient of friction, regardless of when the previous coefficient of friction was stored in the roadway coefficient of friction database 135. It should be understood that a combination of the above examples may be used by the first electronic processor 300 to determine when to replace the previous coefficient of friction associated with the location with the current coefficient of friction associated with the location.

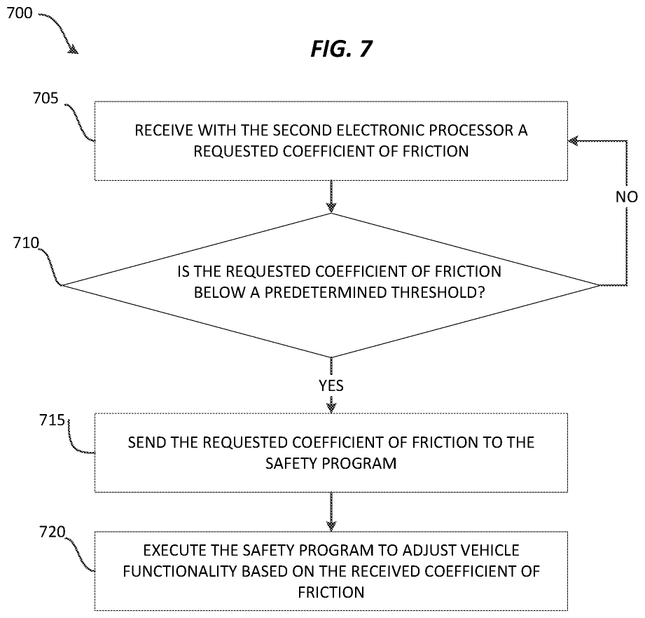

At step 515, the first electronic processor 300 receives, from a vehicle (for example, the first vehicle 105), a request for a coefficient of friction associated with a location (for example, a current location of the first vehicle 105 determined by the GPS 225). In response to receiving the request for a coefficient of friction, the electronic computing device 130 retrieves the coefficient of friction associated with the received location from the roadway coefficient of friction database 135. At step 520, the electronic computing device 130 transmits the coefficient of friction associated with the received location to the first vehicle 105. It should be understood that, in some embodiments, the first electronic processor 300 receives a request for multiple coefficients of friction associated with, for example, one of each location included in a suggested route and transmits the coefficient of friction associated with one of each of the locations included in the suggested route. At step 525, second electronic processor 400 performs a preventative measure based on the received coefficient of friction. FIG. 7 illustrates an example of a method 700 for performing a preventative measure. In step 705 the second electronic processor 400 receives the requested coefficient of friction. At step 710, the second electronic processor 400 determines if the requested coefficient of friction is less than or equal to a predetermined threshold (for example, 0.6). If the requested coefficient of friction is, for example, greater than the predetermined threshold, the second electronic processor 400 does not perform a preventative measure. If the requested coefficient of friction is, for example, less than or equal to the predetermined threshold, the second electronic processor 400 inputs the requested coefficient of friction to the safety program 430 at step 715. At step 720 second electronic processor 400 executes the safety program 430 to adjust vehicle functionality based on the requested coefficient of friction as a preventative measure. Adjusting the functionality of the vehicle includes at least one selected from the group consisting of setting a time gap (a time it would take a following vehicle traveling at a first speed to contact a leading vehicle traveling at a second speed) of the cruise control program 420 to a higher value, activating a low coefficient of friction mode for the electronic stability program 435, activating seatbelt pre-tensioners, disabling sports mode, lowering thresholds to improve air bag firing times, and adjusting a time a forward collision mitigation program 440 outputs a warning to a driver to give the driver more time to avoid a collision, adjusting a time the forward collision mitigation program 440 sends a signal to the braking control system 215 to apply brakes of the vehicle to give the vehicle more time to slow or stop, lower the maximum braking force the cruise control program 420 may request the braking control system 215 to apply to the vehicle, lower the maximum acceleration force the cruise control program 420 may request the acceleration control system 220 to apply to the vehicle, lower a maximum propulsion torque increase the cruise control program may request be applied to the vehicle, and lower estimated wheel locking pressure. In some embodiments the preventative measure is adjusting a route suggested by the navigation program 425. The adjusted route suggested by the navigation program 425 has a higher average coefficient of friction than a previously suggested route.

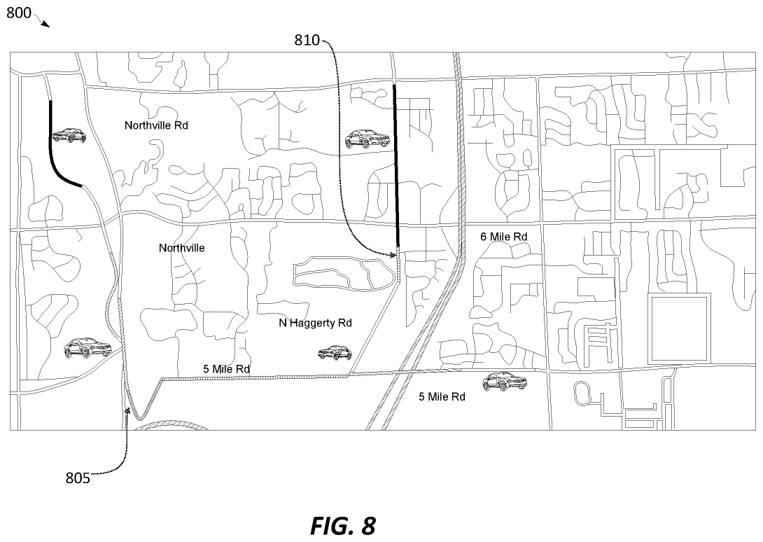

In some embodiments, the second electronic processor 400, executing the navigation program 425, displays, via the display device 205, one or more suggested routes and the coefficients of friction along the routes. FIG. 8 illustrates an example of a map 800 displayed by the display device 205 that includes one or more suggested routes and an indication of the coefficients of friction associated with the roadways of the suggested routes (in other words, the coefficient of friction at each location of a suggested route). The coefficient of friction of the roadway may be indicated on the map 800 by the color (illustrated in FIG. 8 with shading) of the route. For example, the section 805 of the suggested route marked with the color blue in the map 800 may indicate that the roadway of that section 805 of the suggested route has a lower coefficient of friction than a section 810 of the suggested route marked with the color red in the map 800.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Various features, advantages, and embodiments are set forth in the following claims.

1. A system for modifying vehicle behavior based on data from a dynamically updated roadway coefficient of friction database, the system comprising:
the roadway coefficient of friction database;
an electronic computing device including:
a first electronic processor configured to:
receive a current coefficient of friction and a location of a vehicle;
depending on a criterion, replace, in the roadway coefficient of friction database, a previous coefficient of friction associated with the location with the current coefficient of friction;
receive, from a vehicle, a request for a coefficient of friction associated with a location; and
transmit, to the vehicle, the coefficient of friction associated with the location; and
a plurality of vehicles, wherein each vehicle includes a second electronic processor and each second electronic processor is configured to:
perform a preventative measure based on the coefficient of friction received from the electronic computing device.

2. The system according to claim 1, wherein the preventative measure includes at least one selected from the group consisting of adjusting functionality of the vehicle via a safety program and adjusting a route suggested by a navigation program.

3. The system according to claim 2, wherein adjusting functionality of the vehicle via a safety program includes performing at least one selected from the group of setting a time gap of a cruise control program to a higher value, activating a low coefficient of friction mode for an electronic stability program, activating seatbelt pre-tensioners, disabling sports mode, lowering thresholds to improve air bag firing times, adjusting a time a forward collision mitigation program outputs a warning to give a driver of the vehicle more time to avoid a collision, adjusting a time a forward collision mitigation program sends a signal to apply brakes of the vehicle to give the vehicle more time to slow or stop, lower a maximum braking force the cruise control program may request be applied to the vehicle, lower a maximum acceleration force the cruise control program may request be applied to the vehicle, lower a maximum propulsion torque increase the cruise control program may request be applied to the vehicle, and lower estimated wheel locking pressure.

4. The system according to claim 2, wherein the adjusted route suggested by the navigation program has a higher average coefficient of friction.

5. The system according to claim 1, wherein each second electronic processor is configured to:
receive, from a sensor, a signal indicating wheel slippage;
determine a force applied to the vehicle by a braking control system or an acceleration control system; and
determine a coefficient of friction using the force and whether the signal indicating wheel slippage is received.

6. The system according to claim 1, wherein the criterion is at least one selected from the group consisting of weather conditions at the location, a rate of vehicles traveling through the location, an amount of time that has passed since the previous coefficient of friction was added to the roadway coefficient of friction database.

7. The system according to claim 1, wherein each second electronic processor is configured to:
display, via a display device, a map including a suggested route and, for each location included in the suggested route, an indication of the coefficient of friction associated with the location.

8. A method for modifying vehicle behavior based on data from a dynamically updated roadway coefficient of friction database, the method comprising:
receiving, with a first electronic processor of an electronic computing device, a current coefficient of friction and a location of a vehicle;
depending on a criterion, replacing, in the roadway coefficient of friction database, a previous coefficient of friction associated with the location with the current coefficient of friction;
receiving, with the first electronic processor, a request for a coefficient of friction associated with a location from a vehicle;
transmitting, with the first electronic processor, the coefficient of friction associated with the location to the vehicle; and
performing, with a second electronic processor of the vehicle, a preventative measure based on the coefficient of friction received from the electronic computing device.

9. The method according to claim 8, wherein the preventative measure includes at least one selected from the group consisting of adjusting functionality of the vehicle via a safety program and adjusting a route suggested by a navigation program.

10. The method according to claim 9, wherein adjusting functionality of the vehicle via a safety program includes performing at least one selected from the group of setting a time gap of a cruise control program to a higher value, activating a low coefficient of friction mode for an electronic stability program, activating seatbelt pre-tensioners, disabling sports mode, lowering thresholds to improve air bag firing times, adjusting a time a forward collision mitigation program outputs a warning to give a driver of the vehicle more time to avoid a collision, adjusting a time a forward collision mitigation program sends a signal to apply brakes of the vehicle to give the vehicle more time to slow or stop, lower a maximum braking force the cruise control program may request be applied to the vehicle, lower a maximum acceleration force the cruise control program may request be applied to the vehicle, lower a maximum propulsion torque increase the cruise control program may request be applied to the vehicle, and lower estimated wheel locking pressure.

11. The method according to claim 9, wherein the adjusted route suggested by the navigation program has a higher average coefficient of friction.

12. The method according to claim 8, the method further comprising:
receiving, with the second electronic processor, a signal indicating wheel slippage from a sensor;
determining a force applied to the vehicle by a braking control system or an acceleration control system; and
determining a coefficient of friction using the force and whether the signal indicating wheel slippage is received.

13. The method according to claim 8, wherein the criterion is at least one selected from the group consisting of weather conditions at the location, a rate of vehicles traveling through the location, an amount of time that has passed since the previous coefficient of friction was added to the roadway coefficient of friction database.

14. The method according to claim 8, the method further comprising:
displaying, via a display device, a map including a suggested route and, for each location included in the suggested route, an indication of the coefficient of friction associated with the location.
